(19) United States
(12) Patent Application Publication
(10) Pub. No.: US 2006/0231575 A1
(43) Pub. Date: Oct. 19, 2006

(54) Salt shaker for roof de-icing

(76) Inventor: Paul Sroufe, Manchester, MI (US)

Correspondence Address: John G. Posa;Gifford, Krass, Groh, Sprinkle,, Anderson & Citkowski, P.C., PO Box 7021, Troy, MI, 48007-7021, US

(21) Appl. No.: 11/359,282

(22) Filed: Feb. 22, 2006

Related U.S. Application Data
(60) Provisional application No. 60/655,254, filed on Feb. 22, 2005.

(51) Int. Cl. B67D 5/64

(52) U.S. Cl. 222/174; 222/565

(57) ABSTRACT

An implement for applying rock salt or other snow/ice-melting materials onto a roof comprises a can having a bottom surface with apertures to release the snow/ice-melting material through shaking; and an extension pole attached to the can, enabling the can to be positioned over a roof and shaken to release the snow/ice-melting materials. The extension pole is preferably attached to the can at an angle less than 90°. The apertures are preferably on the order of ⅛ to ⅜ of an inch in diameter. The extension pole is telescoping or may include multiple coupled segments.

### REFERENCE TO RELATED APPLICATION

This application claims priority from U.S. Provisional Patent Application Ser. No. 60/655,254, filed Feb. 22, 2005, the entire content of which is incorporated herein by reference.

### FIELD OF THE INVENTION

This invention relates generally to roof de-icing and, in particular, to a salt shaker for this purpose.

### BACKGROUND OF THE INVENTION

In colder climates, it is not uncommon for snow and ice to accumulate on the roofs of homes and businesses. In some situations, this creates “ice dams” which tend to build up around the edge of the roof or near gutters. These ice dams prevent ice, snow and water further up on the roof from escaping, which often leads to leaks and roof damage.

Several techniques are used to prevent or remove ice dams. To prevent them, some occupants install electrical heater tape or wire near the edge of the roof, which melts off any accumulated ice or snow, thereby preventing the ice dam from forming. Others use “roof rakes” to remove snow accumulation near the edge of the roof, thereby preventing the excess accumulation from forming an ice dam. Still others apply rock salt to the edge of the roof, but because there is no suitable way to apply such salt, it is thrown onto the roof in a haphazard fashion, often leading to an unsatisfactory result.

### SUMMARY OF THE INVENTION

This invention resides in an implement for applying rock salt or other snow/ice-melting materials onto a roof. The preferred embodiment comprises a can having a bottom surface with apertures to release the snow/ice-melting material through shaking; and an extension pole attached to the can, enabling the can to be positioned over a roof and shaken to release the snow/ice-melting materials. The extension pole is preferably attached to the can at an angle less than 90°. The apertures are preferably on the order of ⅛ to ⅜ of an inch in diameter. The extension pole is telescoping or may include multiple coupled segments.

### BRIEF DESCRIPTION OF THE DRAWING

FIG. 1 shows a shaker can attached to a pole at an angle.

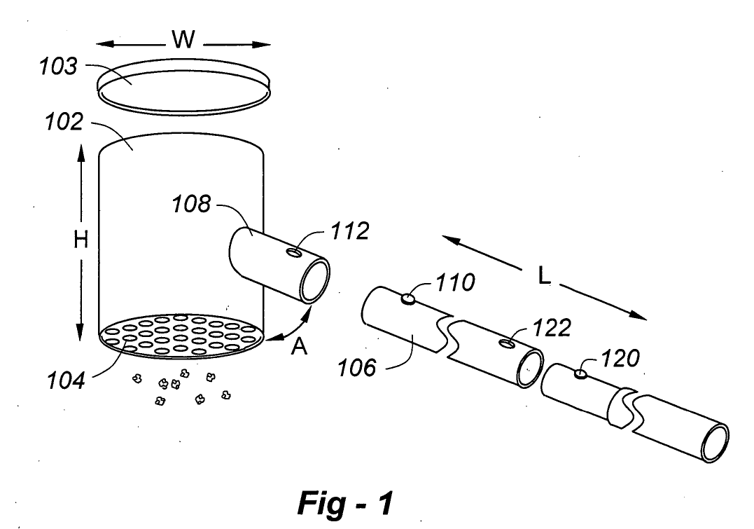

### DETAILED DESCRIPTION OF THE INVENTION

This invention improves upon existing techniques, by providing a specialized “salt shaker” for the application of rock salt or other ice-melting materials onto a roof without the danger of climbing onto the roof or spreading such materials in a haphazard manner. In a preferred embodiment, shown in the Figure, a shaker can is attached to a pole at an angle, such that when the can is held over a roof with the pole at an angle, the can is preferably generally upright so that the contents of the can may be uniformly emptied for a desired application.

The can 102 may be made of any suitable material, such as plastic or metal. A lid 103 is preferably though optionally provided, with the overall dimensions being W on the order of 3 to 10 inches and H on the order of 3 to 13 inches though the invention is not limited in this regard.

Apertures 104 are formed in the can, and these apertures may either be formed in the end of the can which does not open or, alternatively, may be formed in the cap used to refill the container. Preferably, the apertures are formed in the non-cap end, to eliminate the possibility that the cap comes off during application. The apertures may be of any size suitable for the release of snow-and-ice melting materials. The diameter of the apertures, therefore, is preferably in the range of ⅛ to ⅜ of an inch, or thereabouts.

The pole 106 may be attached to the can at an angle, but preferably in the range of the pitch associated with most roofs. Accordingly, this angle is in the range of 30 to 60 degrees, or thereabouts. It should be noted that the angle is not absolutely necessary to the invention, as 90 degrees may be used; however, it may be difficult to empty the entire contents of the can. Therefore, an angled pole is preferred.

The pole may either attach permanently to the can or, in the preferred embodiment, the can includes a collar 108 into which a pole is received, along with a fastener for retaining the pole within the sleeve, such as a pin or spring-loaded projection 110 in the corresponding pole piece to be received by aperture 112 in the collar. The pole is preferably on the order of 8 feet or greater, and may be telescoping or may utilize coupled extension members 114 for greater length. Again, if coupled members are used, some mechanism, such as a pin or spring-loaded projection 120 and corresponding aperture 122 are used to at least temporarily lock the pole sections in place.

I claim:

1. A tool for applying rock salt or other snow/ice-melting materials onto a roof, comprising:
a can having a bottom surface with apertures to release the snow/ice-melting material through shaking; and
an extension pole attached to the can, enabling the can to be positioned over a roof and shaken to release the snow/ice-melting materials.

2. The apparatus of claim 1, wherein the extension pole is attached to the can at an angle less than 90°.

3. The apparatus of claim 1, wherein the apertures are on the order of ⅛ to ⅜ of an inch in diameter.

4. The apparatus of claim 1, wherein the extension pole is telescoping.

5. The apparatus of claim 1, wherein the extension pole includes multiple coupled segments.
